(19) United States
(12) Patent Application Publication
(10) Pub. No.: US 2025/0192261 A1
(43) Pub. Date: Jun. 12, 2025

(54) BATTERY MODULE

(71) Applicants: HYUNDAI MOTOR COMPANY, Seoul (KR); KIA CORPORATION, Seoul (KR); HYUNDAI MOBIS CO., LTD., Seoul (KR)

(72) Inventors: Jun Ho Suh, Gwacheon-si (KR); Hyun Woo Yoon, Gimpo-si (KR); Yoon Hyuk Kang, Seoul (KR); June Ho Lee, Jeollanam-do (KR); Hwa Sung Kim, Pyeongtaek-si (KR); Yong Jung Kim, Uiwang-si (KR)

(73) Assignees: HYUNDAI MOTOR COMPANY, Seoul (KR); KIA CORPORATION, Seoul (KR); HYUNDAI MOBIS CO., LTD., Seoul (KR)

(21) Appl. No.: 18/806,001

(22) Filed: Aug. 15, 2024

(30) Foreign Application Priority Data
Dec. 11, 2023 (KR) 10-2023-0179011

(51) Int. Cl. H01M 10/613; H01M 10/653; H01M 10/6556; H01M 50/242; H01M 50/249; H01M 50/262

(52) U.S. Cl. CPC H01M 10/613; H01M 10/653; H01M 10/6556; H01M 50/242; H01M 50/249; H01M 50/262

(57) ABSTRACT

A battery module secures cooling performance of a battery cell by cooling upper and lower parts of the battery cell, and also secures the assemblability of the battery cell through an upper and lower-side cooling structure. In addition, the battery module includes: a lower frame coupled to lower sides of side panels and cover plates to form a support structure and having a lower heat transfer member; and an upper frame coupled to upper sides of the side panels and the cover plates to form another support structure and having an upper heat transfer member, thereby securing the stability of the battery cells by supporting an expansive force attributable to the swelling of the battery cell.

### CROSS REFERENCE TO RELATED APPLICATION

This application claims priority to Korean Patent Application No. 10-2023-0179011 filed on Dec. 11, 2023, the entire contents of which are incorporated herein by reference.

### FIELD

The present disclosure relates to a battery module mounted on a vehicle.

### BACKGROUND

In general, a battery module is constructed by stacking multiple battery cells, and is constructed by assembling various parts for promoting cooling while securing the structural stability of the stacked battery cells and also preparing for the swelling of the battery cell. The battery module has a predetermined size and thus its output voltage is determined to be constant.

In other words, the battery module has been modulated by electrically connecting a plurality of battery cells due to the necessity of a high output and a high capacity. An electric vehicle includes a battery pack in which a plurality of battery modules is accommodated in order to obtain high power.

In order to construct a high-capacity and large-area battery pack or battery module, the number of battery cells may also be increased. Accordingly, improving assembly efficiency and reducing the weight of the battery module by simplifying the structure of the battery module is desired.

Furthermore, the electrode assembly of the battery cell generates heat while experiencing charging and discharging processes. There is a problem in that electrical performance of the battery module is degraded or a fire is caught in the battery module when an internal temperature of the battery module rises due to the generation of heat.

Particularly, if many battery modules or battery cells are mounted within a battery pack, there is a problem in that a chain of fires or explosions occurs because a flame that occurs by the ignition of any one battery module is transferred or propagate to another nearby battery module or other battery cells.

Conventionally, for the purpose of cooling the battery cell, a cooling channel is constructed on the lower side of the battery pack so that the cooling of the battery cell is performed. However, if the battery cell is cooled only at the bottom of the battery cell, the temperature management of the battery cell is inefficient because a temperature deviation occurs between the top and bottom of the battery cell.

Furthermore, conventionally, for the structural simplification of the battery pack, a cover is disposed at the top of the battery pack. In this case, securing both cooling performance and structural stiffness of the battery pack is limited.

The matters explained as the background art are for the purpose of enhancing the understanding of the background of the present disclosure and should not be taken as acknowledging that they correspond to the related art already known to those having ordinary skill in the art.

### SUMMARY

The present disclosure is directed to providing a battery module which secures cooling performance of a battery cell through cooling upper and lower parts of the battery cell, and also secures the assemblability of the battery cell according to an upper and lower-side cooling structure. Furthermore, the battery module secures the stability of the battery cell by supporting an expansive force attributable to the swelling of the battery cells. In other words, the battery module helps maintain the stability of the battery cell by providing support against the expansion force caused by the swelling of the battery cells.

In an embodiment of the present disclosure, a battery module includes: side panels within which a plurality of battery cells is pressurized and stacked; and cover plates each including a plurality of sensing boards that is electrically connected to the battery cell. The battery module further includes a lower frame coupled to lower sides of the side panels and the cover plates to form a support structure. In particular, the lower frame includes a lower heat transfer member that is subjected to a heat exchange with a lower cooling channel. The battery module also includes an upper frame coupled to upper sides of the side panels and the cover plates to form a support structure. The upper frame includes an upper heat transfer member that is subjected to a heat exchange with an upper cooling channel.

The cover plate is connected to the sensing board by any one of a push latch method, a snap fit method, and a Velcro method according to a fitting connection method.

In one embodiment, a lower bending part that is upward bent to come into contact with the side panel is formed in the lower frame. A fastening member is laterally fastened to the lower bending part and the side panel through the lower bending part and the side panel.

In one embodiment, a lower flange part that is extended to surround a part of the lower side of the cover plate is formed in the lower frame. A fastening member is fastened to the lower flange part and the sensing board through the lower flange part and the sensing board from a lower side thereof to an upper side.

In one embodiment, the battery module further includes a support plate disposed outside the cover plate. The support plate is formed to surround a part of the upper side of the cover plate and connected to the lower flange part.

In one embodiment, a penetration part is formed in the support plate to match with a bracket part provided in the cover plate, and the bracket part passes through the penetration part.

In one embodiment, a connection end is formed in the upper frame. In particular, the connection end may be extended to the upper side of the cover plate and connected to a top of the support plate.

In one embodiment, an upper bending part that is downward bent to come into contact with the side panel is formed in the upper frame. The fastening member is laterally fastened to the upper bending part and the side panel through the upper bending part and the side panel.

In one embodiment, a trapping protrusion part is formed in the side panel. A seated groove part into which the trapping protrusion part is inserted and that is seated in the trapping protrusion part is formed in the upper bending part of the upper frame.

The battery module is constructed in an assembly order in which the cover plates including the sensing boards are assembled in a state in which the battery cells have been stacked between the side panels, the lower frame is fastened to the side panels and the sensing boards, the support plate is fastened to the sensing boards and the lower frame, and the upper frame is fastened to the support plate and the side panels.

In one embodiment, a lower reinforcement part that is extended to intersect the lower frame in a direction in which the battery cells have been stacked is formed in the lower frame.

In one embodiment, a lower recessed part that is matched with the lower reinforcement part is formed in the lower heat transfer member so that the lower reinforcement part is seated in the lower recessed part.

In one embodiment, the lower heat transfer member has an upper surface coming into contact with the battery cell and a lower surface coming into contact with the lower cooling channel and is constructed by using a material having high thermal conductivity.

In one embodiment, a thermal conductive material is applied or a thermal conductive pad is provided between the lower heat transfer member and the lower cooling channel or between the lower heat transfer member and the battery cell.

In one embodiment, an upper reinforcement part that is extended to intersect the upper frame in a direction in which the battery cells have been stacked is formed in the upper frame.

In one embodiment, an upper recessed part that is matched with the upper reinforcement part is formed in the upper heat transfer member so that the upper reinforcement part is seated in the upper recessed part.

In one embodiment, the upper heat transfer member has a lower surface coming into contact with the battery cell and an upper surface coming into contact with the upper cooling channel, and is constructed by using a material having high thermal conductivity.

In one embodiment, a thermal conductive material is applied or a thermal conductive pad is provided between the upper heat transfer member and the upper cooling channel or between the upper heat transfer member and the battery cell.

The battery module having the aforementioned structure secures cooling performance of a battery cell, secures the assemblability of the battery cell according to the upper and lower-side cooling structure, and secures the stability of the battery cell by supporting an expansive force attributable to the swelling of the battery cell through the cooling of the upper and lower parts of the battery cell.

### BRIEF DESCRIPTION OF THE DRAWINGS

The above and other objects, features and other advantages of the present disclosure should be clearly understood from the following detailed description when taken in conjunction with the accompanying drawings, in which:

FIG. 1 is a diagram illustrating a battery module according to an embodiment of the present disclosure;

FIG. 2 is a cross sectional view of the battery module illustrated in FIG. 1;

FIG. 3 is an enlarged view of a portion “A” in the battery module illustrated in FIG. 2;

FIG. 4 is a perspective view illustrating battery cells and side panels of the battery module illustrated in FIG. 1;

FIG. 5 is a perspective view illustrating the assembly of a cover plate of the battery module illustrated in FIG. 1;

FIG. 6 is a diagram illustrating the assembly of the cover plate and sensing board of the battery module illustrated in FIG. 1;

FIG. 7 is a perspective view illustrating the assembly of a lower frame of the battery module illustrated in FIG. 1;

FIG. 8 is a diagram illustrating the assembly of the lower frame and side panel of the battery module illustrated in FIG. 1;

FIG. 9 is a perspective view illustrating the assembly of a support plate of the battery module illustrated in FIG. 1;

FIG. 10 is a diagram illustrating an upper frame of the battery module illustrated in FIG. 1;

FIG. 11 is a diagram illustrating the assembly of the upper frame of the battery module illustrated in FIG. 1; and

FIG. 12 is a diagram illustrating the assembly of the upper frame, support frame, and side panel of the battery module illustrated in FIG. 1.

### DETAILED DESCRIPTION

Hereinafter, embodiments of the present disclosure are described in detail with reference to the accompanying drawings, and the same or similar components are denoted by the same reference numerals regardless of the drawing symbols, and overlapping descriptions thereof have been omitted.

The suffixes “module” and “unit” for components used in the following description are given or used interchangeably in consideration of ease of writing the specification and not have meanings or roles that are distinct from each other by themselves.

In describing the embodiments, when it is determined that a detailed description of a related known technology may obscure the gist of the embodiments disclosed in this disclosure, a detailed description thereof has been omitted. In addition, the accompanying drawings are only for easy understanding of the embodiments disclosed in the present disclosure, and it should be understood that the technical spirit disclosed in the present disclosure is not limited by the accompanying drawings and should include all changes, equivalents, or substitutes included in the spirit and technical scope of the present disclosure.

Terms including ordinal numbers such as first or second may be used to describe various components, but the components are not limited by the terms. The terms are used only for the purpose of distinguishing one component from another.

When a first component is described as being “connected” or “coupled” to a second component, it should be understood that the first component may be directly connected or coupled to the second component or a third component may be present therebetween. On the other hand, when the first component is described as being “directly connected” or “directly coupled” to the second component, it should be understood that the third component is not present therebetween.

The singular expression includes the plural expression unless the context clearly dictates otherwise. When a component, device, element, or the like of the present disclosure is described as having a purpose or performing an operation, function, or the like, the component, device, or element should be considered herein as being “configured to” meet that purpose or to perform that operation or function.

In the present disclosure, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, components, operations, parts, or combinations thereof.

Hereinafter, a battery module according to an embodiment of the present disclosure is described with reference to the accompanying drawings.

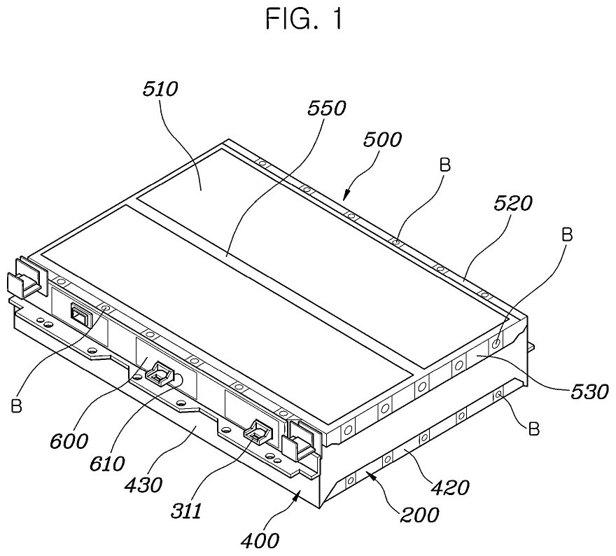

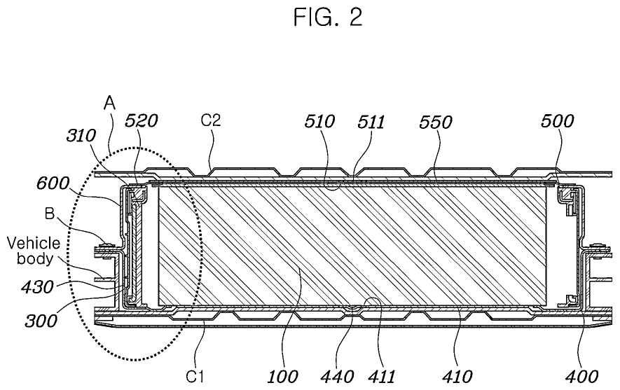

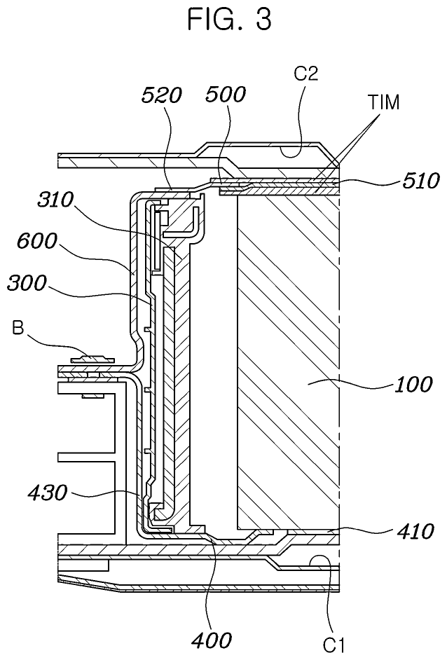

As illustrated in FIGS. 1 to 12, the battery module according to an embodiment of the present disclosure includes side panels 200 in which a plurality of battery cells 100 is pressurized and stacked; and cover plates 300 each including a sensing board 310 that is electrically connected to the battery cell 100. The battery module further includes a lower frame 400 that forms a support structure by being coupled to a lower side of the side panels 200 and the cover plates 300 and that is provided with a lower heat transfer member 410 subjected to a heat exchange with a lower cooling channel C1. The battery module further includes: an upper frame 500 that forms a support structure by being coupled to an upper side of the side panels 200 and the cover plates 300. In particular, the upper frame 500 is provided with an upper heat transfer member 510 subjected to a heat exchange with an upper cooling channel C2.

The battery module has the battery cell 100 capable of being charged and discharged constructed therein in a plural number, and stores or discharges electric energy. The battery cell 100 may be constructed as a secondary cell, such as a lithium ion cell or a nickel-hydride cell.

The battery cell 100 is protected through the side panels 200, the cover plate 300, a lower plate, and an upper plate, and forms a battery pack. The lower plate and the upper plate cover upper and lower parts of the battery pack and are not illustrated in the drawings.

The side panel 200 is constructed as a pair, and the pair of side panels 200 is provided on both sides in a direction in which the plurality of battery cells 100 is stacked. The side panels 200 provide applied pressure to the direction in which the battery cells 100 are stacked so that the swelling of the battery cells 100 is suppressed.

The cover plate 300 is constructed as a pair, and the pair of cover plates 300 is provided in a direction orthogonal to the direction in which the battery cells 100 have been stacked. The sensing board 310 that is electrically connected to the plurality of battery cells 100 is provided within the cover plate 300. The sensing board 310 may include a temperature sensor or a voltage sensor.

Accordingly, the plurality of battery cells 100 and the sensing board 310 form a structure in which the battery cells 100 and the sensing board 310 are protected by the side panels 200 and the cover plates 300.

In an embodiment of the present disclosure, the lower frame 400 is provided under the battery cell 100. The upper frame 500 is provided over the battery cell 100.

The lower frame 400 includes the lower heat transfer member 410 that is coupled to the lower side of the side panels 200 and the cover plates 300 and that comes into contact with a lower part of the battery cell 100. The lower frame 400 may be constructed by using a material having high strength, and may be fabricated as a high tension steel plate. Accordingly, the lower frame 400 has a robust support structure with respect to the side panels 200 and the cover plates 300, so that surface pressure maintenance performance for the battery cell 100 is secured.

The lower heat transfer member 410 may be constructed by using a material having high thermal conductivity, and may be made of aluminum, for example.

Furthermore, the lower heat transfer member 410 comes into contact with the lower cooling channel C1, so that a cooling fluid that flows into the lower cooling channel C1 is subjected to a heat exchange with the battery cell 100 through the medium of the lower heat transfer member 410.

In other words, the lower heat transfer member 410 has an upper surface coming into contact with the battery cells 100 and a lower surface coming into contact with the lower cooling channel C1 and is constructed by using a material having high thermal conductivity, so that heat exchange efficiency between the lower part of the battery cell 100 and the cooling fluid can be secured.

In this case, a thermal conductive material may be applied or a thermal conductive pad may be provided between the lower heat transfer member 410 and the lower cooling channel C1 or between the lower heat transfer member 410 and the battery cell 100.

For example, the thermal conductive material or the thermal conductive pad may be a thermal interface material (TIM). Heat exchange efficiency can be further improved because the TIM is applied between the lower heat transfer member 410 and the lower cooling channel C1 and between the lower heat transfer member 410 and the battery cell 100.

The upper frame 500 includes the upper heat transfer member 510 that is coupled to the upper side of the side panels 200 and the cover plates 300 and that comes into contact with an upper part of the battery cell 100. The upper frame 500 may be constructed by using a material having high strength, and may be fabricated as a high tension steel plate. Accordingly, the upper frame 500 forms a robust support structure with respect to the side panels 200 and the cover plates 300, so that surface pressure maintenance performance for the battery cell 100 is secured.

The upper heat transfer member 510 may be constructed by using a material having high thermal conductivity, and may be made of aluminum, for example.

Furthermore, the upper heat transfer member 510 comes into contact with the upper cooling channel C2, so that a cooling fluid that flows into the upper cooling channel C2 is subjected to a heat exchange with the battery cell 100 through the medium of the upper heat transfer member 510.

In other words, the upper heat transfer member 510 includes: a lower surface coming into contact with the battery cell 100, and an upper surface coming into contact with the upper cooling channel C1. The upper heat transfer member 510 is constructed by using a material having high thermal conductivity, so that heat exchange efficiency between the upper part of the battery cell 100 and the cooling fluid can be secured.

In this case, a thermal conductive material may be applied or a thermal conductive pad may be provided between the upper heat transfer member 510 and the upper cooling channel C1 or between the upper heat transfer member 510 and the battery cell 100.

As described above, according to an embodiment of the present disclosure, cooling performance of the battery cell 100 is secured through the cooling of the upper and lower parts of the battery cell 100, and the stability of the battery cell 100 is secured because an expansive force attributable to the swelling of the battery cell 100 is supported.

The aforementioned embodiment of the present disclosure is specifically described. The cover plates 300 may be connected to the sensing board 310 by using any one of a push latch method, a snap fit method, and a Velcro method, according to a fitting connection method.

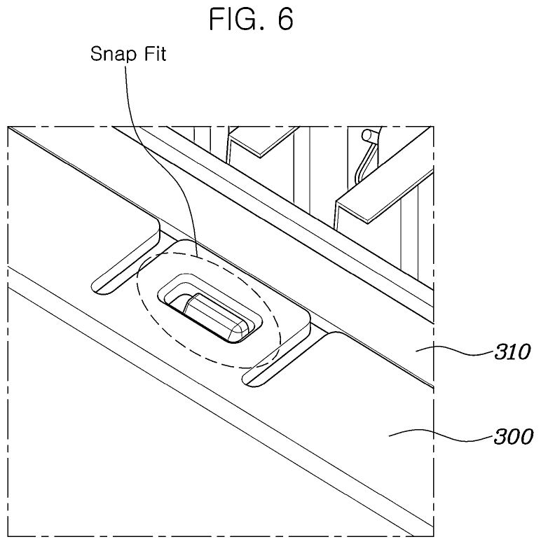

In an embodiment of the present disclosure, as illustrated in FIG. 6, it is assumed that the cover plates 300 is connected and fixed to the sensing board 310 by using the snap fit method.

Connection convenience of the cover plate 300 and the sensing board 310 is improved because the cover plate 300 is connected to the sensing board 310 by the fitting connection method having a simple assembly structure as described above. Particularly, a robust connection structure for the battery cells can be secured while securing the assemblability of the battery cell because the cover plate 300 is fully fixed to the sensing board 310 through the lower frame 400, the upper frame 500, and a support plate 600 to be described later in the state in which the cover plate 300 has been temporarily fixed to the sensing board 310 by the fitting connection method.

A lower bending part 420 that is upward bent and formed so that the lower bending part 420 comes into contact with the side panel 200 is formed in the lower frame 400. A fastening member B may be fastened to the lower bending part 420 and the side panel 200 laterally through the lower bending part 420 and the side panel 200.

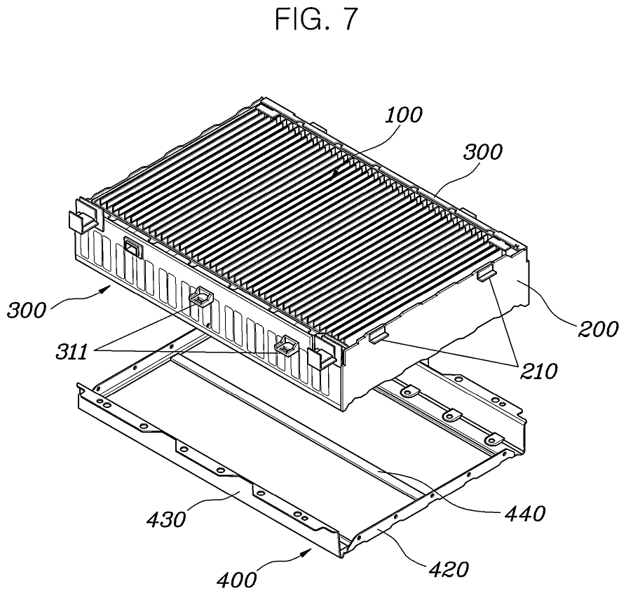

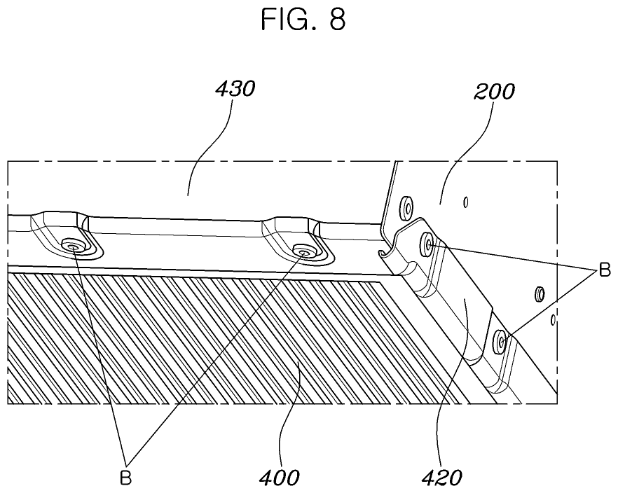

As illustrated in FIGS. 7 and 8, the lower bending part 420 is formed in the lower frame 400. The lower bending part 420 is upward bent and formed to come into contact with the bottom of the side panel 200 at an edge of the lower frame 400.

The lower bending part 420 may be formed as a pair so that the pair of lower bending parts 420 comes into contact with the side panels 200 on both sides of the lower frame 400, respectively.

Accordingly, the lower frame 400 forms a support structure for the side panels 200 that pressurize the plurality of battery cells 100, and can support a force that is expanded upon swelling of the battery cell 100.

Furthermore, the lower bending parts 420 of the lower frame 400 are coupled to the side panels 200. The fastening member B forms a robust support structure even by a force with respect to a direction in which the fastening member B is fastened because the fastening member B is fastened to the lower bending parts 420 and the side panels 200 laterally through the lower bending parts 420 and the side panels 200.

A lower flange part 430 that is extended to surround a part of a lower part of the cover plate 300 is formed in the lower frame 400. The fastening member B may be fastened to the lower flange part 430 and the sensing board 310 through the lower flange part 430 and the sensing board 310 from a lower side thereof to an upper side.

As may be seen in FIGS. 7 and 8, the lower flange part 430 is formed in the lower frame 400. The lower flange part 430 is upward bent and formed so that the lower flange part 430 comes into contact with the bottom of the cover plate 300 at the edge of the lower frame 400.

The lower flange part 430 may be formed as a pair so that the pair of lower flange parts 430 comes into contact with the cover plates 300 on both sides of the lower frame 400, respectively.

Accordingly, the location of the cover plate 300 fixed to the sensing board 310 is fixed because a part of the lower side of the cover plate 300 is surrounded by the lower flange part 430 of the lower frame 400. As the lower flange part 430 supports the cover plate 300, the cover plate 300 can support a force that expands when the battery cell 100 swells.

Furthermore, the lower flange part 430 is coupled to the sensing board 310, and the fastening member B is fastened to the lower flange part 430 and the sensing board 310 through the lower flange part 430 and the sensing board 310 from the lower side thereof to the upper side. Accordingly, a robust support structure of the sensing board 310 can be formed because the lower frame 400 is fastened to the fastening member B in the direction in which the sensing board 310 is supported when the fastening member B is fastened.

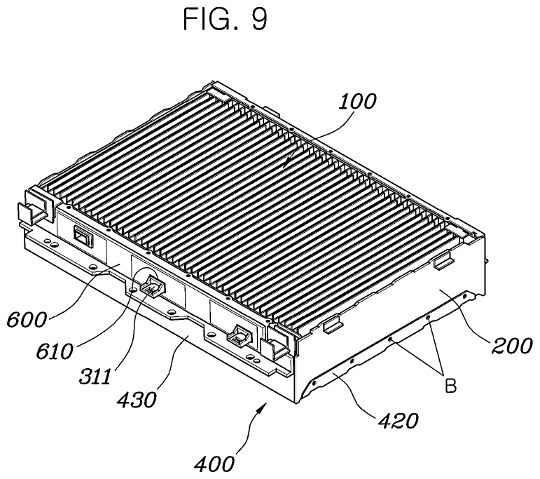

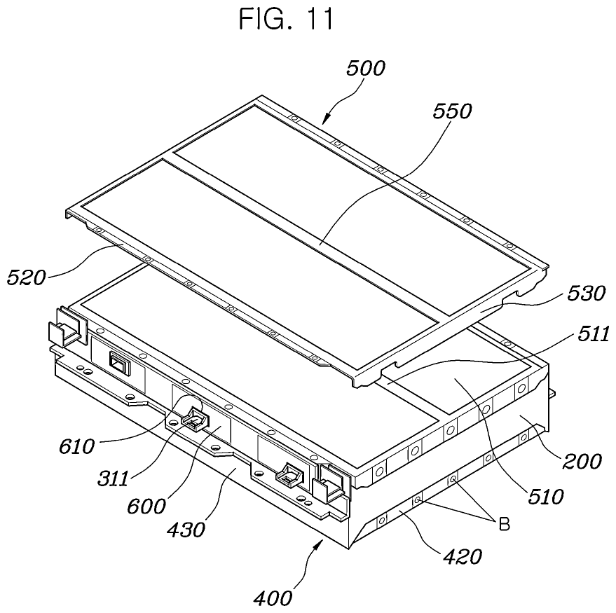

As illustrated in FIGS. 9 and 11, the support plate 600 may be further provided outside the cover plate 300.

The support plate 600 is formed to surround a part of the upper side of the cover plate 300 and connected to the lower flange part 430. The support plate 600 may be constructed by using a material having high strength.

In other words, the cover plates 300 is protected by being covered with the lower frame 400 and the support plate 600 because the support plate 600 is formed to surround a part of the upper side of the cover plate 300, which has been left in the lower frame 400 after being surrounded by the lower flange part 430.

The support plate 600 may be connected to the lower flange part 430 of the lower frame 400. To this end, the bottom of the support plate 600 is bent and extended laterally, and the top of the lower flange part 430 is also identically bent and extended laterally. The fastening member B may be fastened to the support plate 600 and the lower flange part 430 through the support plate 600 and the lower flange part 430 in the state in which the extended parts of the support plate 600 and the lower flange part 430 have been mutually matched.

Through the connection structure of the support plate 600 and the lower frame 400, stable control over surface pressure can be performed because a supporting force is secured from the upper part of the battery cell 100 to the lower part thereof although the surface pressure is increased because the battery cell 100 having a high output is applied.

In this case, a penetration part 610 may be formed in the support plate 600 to match with a bracket part 311 provided in the cover plates 300, and the bracket part 311 passes through the penetration part 610.

In other words, the bracket part 311 to be fixed to a vehicle body is provided in the cover plates 300. As the cover plate 300 is provided inside the support plate 600, the penetration part 610 may be formed in the support plate 600 so that the bracket part 311 may be exposed to the outside.

The number of penetration parts 610 is the same as the number of bracket parts 311. The penetration part 610 is formed to be matched with the bracket part 311 at the same location. The location of the support plate 600 can be stabilized with respect to the cover plate 300 because the bracket part 311 of the cover plate 300 is inserted into the penetration part 610 and forms a support structure for the support plate 600.

In another embodiment, a connection end 520 may be formed in the upper frame 500. In particular, the connection end 520 is extended to the upper side of the cover plate 300 and connected to the top of the support plate 600.

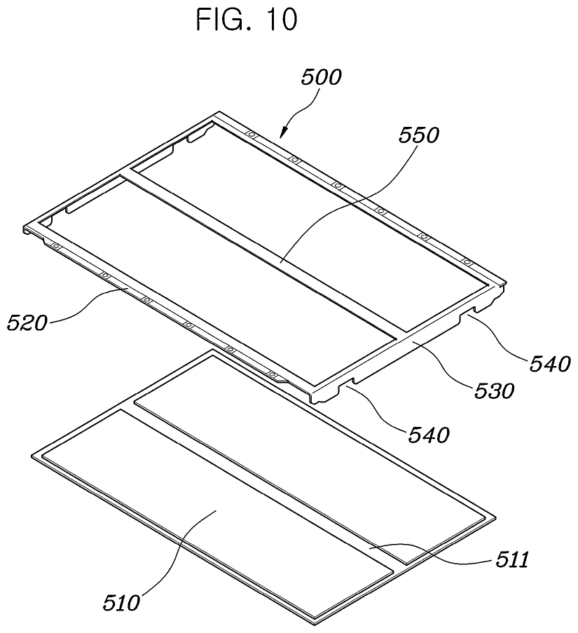

As illustrated in FIGS. 10 and 11, the connection end 520 to be connected to the support plate 600 is formed in the upper frame 500.

The connection end 520 is extended from an edge of the upper frame 500 to the upper side of the cover plate 300 and matched with the top of the support plate 600. The upper frame 500 and the support plate 600 are mutually connected because the fastening member B is fastened to the connection end 520 and the support plate 600 through the connection end 520 and the support plate 600.

In this case, the fastening member B may be fastened to the connection end 520 and the support plate 600 through the connection end 520 and the support plate 600 from an upper side thereof to a lower side thereof.

Accordingly, the support plate 600 may form a robust coupling structure upward and downward by the upper frame 500 and the lower frame 400 because the upper frame 500 is connected to the top of the support plate 600, and the lower frame 400 is connected to the bottom of the support plate 600.

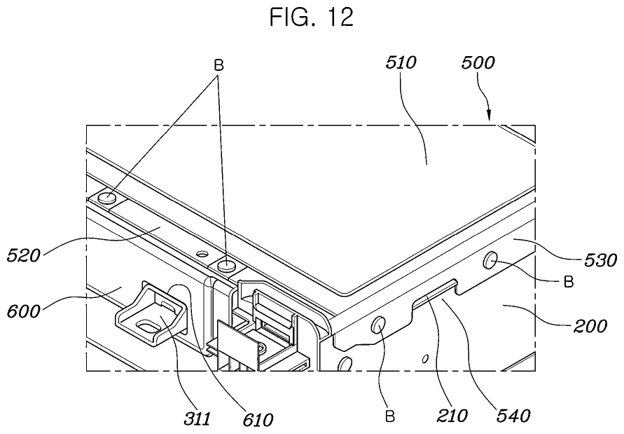

As illustrated in FIG. 12, an upper bending part 530 that is downward bent is formed in the upper frame 500 so that the upper bending part 530 comes into contact with the side panel 200. The fastening member B may be fastened to the upper bending part 530 and the side panel 200 laterally through the upper bending part 530 and the side panel 200.

The upper bending part 530 is formed in the upper frame 500. The upper bending part 530 is formed to be downward bent so that the upper bending part 530 comes into contact with the top of the side panel 200 at the edge of the upper frame 500.

The upper bending part 530 may be formed as a pair so that the pair of upper bending parts 530 comes into contact with the side panels 200 on both sides of the upper frame 500, respectively.

Accordingly, the upper frame 500 forms a support structure for the side panels 200 that pressurize the plurality of battery cells 100. The upper frame 500 can support a force that expands when the battery cell 100 swells, namely providing support against the expansion force caused by the swelling of the battery cells.

Furthermore, the upper bending part 530 of the upper frame 500 is coupled to the side panel 200. The fastening member B is fastened to the upper bending part 530 and the side panel 200 laterally through the upper bending part 530 and the side panel 200. Accordingly, the fastening member B forms a robust support structure because a force is applied in the direction in which the fastening member B is fastened.

As may be seen from FIG. 7, a trapping protrusion part 210 is formed in the side panel 200. A seated groove part 540 into which the trapping protrusion part 210 is inserted and that is seated in the trapping protrusion part 210 may be formed in the upper bending part 530 of the upper frame 500.

That is, the upper frame 500 forms a mutual insertion structure along with the side panel 200 because the seated groove part 540 is matched with the trapping protrusion part 210, so that the upper frame 500 and the side panel 200 form a temporary fixing structure. Accordingly, subsequent fastening tasks between the upper bending part 530 and the side panels 200, and the connection end 520 and the support plate 600 through the fastening member B are easy.

As may be seen in FIG. 7, a lower reinforcement part 440 that is extended to intersect the lower frame 400 in the direction in which the battery cells 100 have been stacked may be formed in the lower frame 400.

As described above, the lower reinforcement part 440 is formed in the lower frame 400. The lower reinforcement part 440 is extended in a straight line in the same direction as the direction in which the battery cells 100 have been stacked.

Expansion suppression performance of the battery cell 100 is improved because the stiffness of the vehicle body of the lower frame 400 is improved by the lower reinforcement part 440 and a supporting force in the direction in which the battery cells 100 have been stacked is reinforced by the lower reinforcement part 440.

In this case, a lower recessed part 411 that is matched with the lower reinforcement part 440 is formed in the lower heat transfer member 410 so that the lower reinforcement part 440 is securely seated in the lower recessed part 411.

Accordingly, the lower heat transfer member 410 can be previously assembled with the lower frame 400 because the lower reinforcement part 440 is inserted and seated in the lower recessed part 411. That is, by matching the lower reinforcement part 440 with the lower recessed part 411, the lower heat transfer member 410 is disposed at its regular position within the lower frame 400, and the assembly state of the lower heat transfer member 410 and the lower frame 400 is maintained. Accordingly, the lower heat transfer member 410 can be disposed under the battery cell 100 through only a process of assembling the lower frame 400 with the side panel 200 and the cover plate 300.

An upper reinforcement part 550 that is extended to intersect the upper frame 500 in the direction in which the battery cells 100 have been stacked may be formed in the upper frame 500.

As described above, the upper reinforcement part 550 is formed in the upper frame 500. The upper reinforcement part 550 is extended in a straight line in the same direction as the direction in which the battery cells 100 have been stacked.

Expansion suppression performance of the battery cell 100 is improved because the stiffness of the vehicle body of the upper frame 500 is improved by the upper reinforcement part 550 and a supporting force in the direction in which the battery cells 100 have been stacked is reinforced by the upper reinforcement part 550.

In this case, an upper recessed part 511 that is matched with the upper reinforcement part 550 is formed in the upper heat transfer member 510 so that the upper reinforcement part 550 is securely seated in the upper recessed part 511.

Accordingly, the upper heat transfer member 510 can be previously assembled with the upper frame 500 because the upper reinforcement part 550 is inserted and seated in the upper recessed part 511. That is, by matching the upper reinforcement part 550 with the upper recessed part 511, the upper heat transfer member 510 is disposed at its regular position within the upper frame 500, and the assembly state of the upper heat transfer member 510 and the upper frame 500 are maintained. Accordingly, the upper heat transfer member 510 can be disposed over the battery cell 100 through only a process of assembling the upper frame 500 with the side panel 200 and the cover plate 300.

The battery module according to an embodiment of the present disclosure secures cooling performance of the battery cell 100 through the cooling of the upper and lower parts of the battery cell 100, and secures the stability of the battery cell 100 by supporting an expansive force attributable to the swelling of the battery cell 100.

Particularly, the battery module according to an embodiment of the present disclosure enables the cooling of the upper and lower surfaces of the battery cell 100 and secures the assemblability of the battery cell 100 in a structure in which the battery cells 100 have been pressurized and stacked.

An assembly process of the battery module according to an embodiment of the present disclosure is as follows.

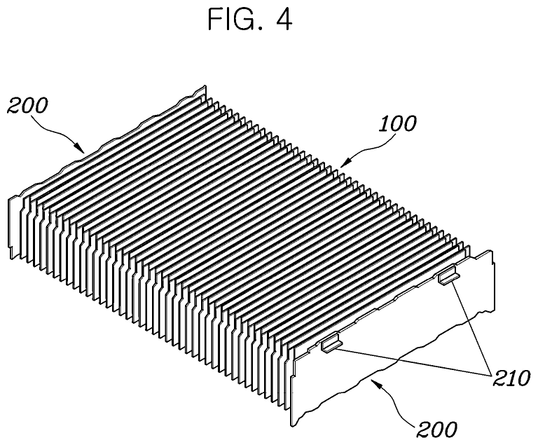

As illustrated in FIG. 4, the battery cells 100 are stacked between the side panels 200, and the battery cell 100 is pressurized through the side panels 200.

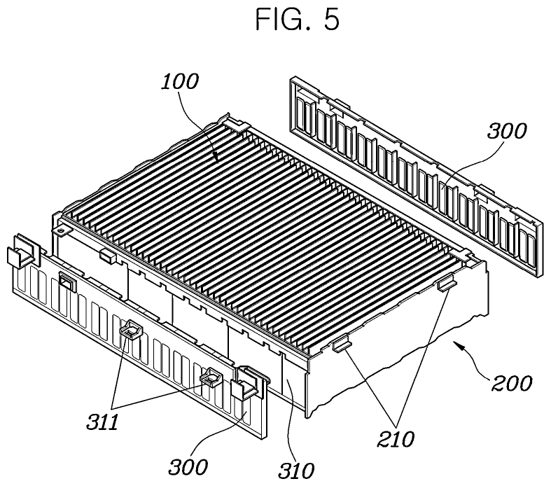

Thereafter, as illustrated in FIG. 5, the sensing board 310 is electrically connected to the battery, and the cover plates 300 are assembled with the sensing boards 310 as a snap fit structure.

In this case, as illustrated in FIG. 7, the lower frame 400 is matched with the lower sides of the side panels 200 and the cover plates 300 that surround the battery cell 100. The side panels 200 and the sensing boards 310 are fastened to the lower frame 400. In this case, the fastening member B is laterally fastened when the side panels 200 and the lower frame 400 are fastened, and is vertically fastened when the sensing board 310 and the lower frame 400 are fastened.

Thereafter, as illustrated in FIG. 9, the support plate 600 is assembled. The location of the support plate 600 is fixed as the support plate 600 is fastened to the sensing board 310 and the lower frame 400.

In this case, as illustrated in FIG. 11, the upper frame 500 is matched with the upper sides of the side panels 200 and the support plate 600 that surround the battery cell 100. The upper frame 500 is fastened to the sensing board 310 and the side panels 200. In this case, the fastening member B is laterally fastened when the side panels 200 and the upper frame 500 are fastened, and is vertically fastened when the sensing board 310, the cover plates 300, and the upper frame 500 are fastened.

Accordingly, finally, the battery module may be constructed as illustrated in FIG. 1.

As described above, in an embodiment of the present disclosure, both the upper and lower parts of the battery cell 100 can be cooled through the upper heat transfer member 510 provided in the upper frame 500 and the lower heat transfer member 410 provided in the lower frame 400.

Particularly, the lower frame 400 and the upper frame 500 are separately constructed, and have an assembly structure in which the lower frame 400 and the upper frame 500 are mutually connected. Accordingly, an upper and lower cooling structure can be applied to the battery cell 100, and the assemblability and structural robustness of the battery cell 100 are secured.

Although the specific embodiments of the present disclosure have been illustrated and described, it will be apparent to those skilled in the art that the present disclosure may be variously improved and changed without departing from the technical spirit of the present disclosure provided by the appended claims.

What is claimed is:

1. A battery module comprising:
side panels within which a plurality of battery cells is pressurized and stacked;
cover plates each comprising a plurality of sensing boards that is electrically connected to at least one of the plurality of battery cells;
a lower frame coupled to lower sides of the side panels and the cover plates to form a support structure and comprising a lower heat transfer member that is subjected to a heat exchange with a lower cooling channel; and
an upper frame coupled to upper sides of the side panels and the cover plates to form another support structure and comprising an upper heat transfer member that is subjected to a heat exchange with an upper cooling channel.

2. The battery module of claim 1, wherein the cover plates are respectively connected to sensing boards of the plurality of sensing boards by at least one of a push latch method, a snap fit method, or a Velcro method, according to a fitting connection method.

3. The battery module of claim 1, wherein:
a lower bending part that is upward bent to come into contact with a corresponding side panel among the side panels is formed in the lower frame, and
a fastening member is laterally fastened to the lower bending part and the corresponding side panel.

4. The battery module of claim 1, wherein:
a lower flange part that is extended to surround a part of a lower side of the cover plate is formed in the lower frame, and
a fastening member is fastened to the lower flange part and the sensing board through the lower flange part and the sensing board from a lower side thereof to an upper side.

5. The battery module of claim 4, further comprising a support plate disposed outside the cover plate,
wherein the support plate is formed to surround a part of the upper side of the cover plate and connected to the lower flange part through a medium of the fastening member.

6. The battery module of claim 5, wherein a penetration part is formed in the support plate to match with a bracket part provided in the cover plate such that the bracket part passes through the penetration part.

7. The battery module of claim 5, wherein a connection end configured to extend to the upper side of the cover plate is formed in the upper frame, and the connection end is connected to a top of the support plate.

8. The battery module of claim 5, wherein:
an upper bending part that is downward bent to come into contact with a corresponding side panel among the side panels is formed in the upper frame, and
the fastening member is laterally fastened to the upper bending part and the corresponding side panel.

9. The battery module of claim 8, wherein:
a trapping protrusion part is formed in the corresponding side panel, and
a seated groove part into which the trapping protrusion part is inserted and that is seated in the trapping protrusion part is formed in the upper bending part of the upper frame.

10. The battery module of claim 5, wherein the battery module is constructed in an assembly order in which the cover plates comprising the plurality of sensing boards are assembled in a state in which the plurality of battery cells have been stacked between the side panels, the lower frame is fastened to the side panels and the plurality of sensing boards, the support plate is fastened to the plurality of sensing boards and the lower frame, and the upper frame is fastened to the support plate and the side panels.

11. The battery module of claim 1, wherein a lower reinforcement part that is extended to intersect the lower frame in a direction in which the plurality of battery cells have been stacked is formed in the lower frame.

12. The battery module of claim 11, wherein a lower recessed part that is matched with the lower reinforcement part is formed in the lower heat transfer member such that the lower reinforcement part is seated in the lower recessed part.

13. The battery module of claim 1, wherein the lower heat transfer member includes: an upper surface coming into contact with the plurality of battery cells; and a lower surface coming into contact with the lower cooling channel, and wherein the lower heat transfer member includes a material having high thermal conductivity.

14. The battery module of claim 13, wherein a thermal conductive material is applied or a thermal conductive pad is provided between the lower heat transfer member and the lower cooling channel or between the lower heat transfer member and the plurality of battery cells.

15. The battery module of claim 1, wherein an upper reinforcement part that is extended to intersect the upper frame in a direction in which the plurality of battery cells have been stacked is formed in the upper frame.

16. The battery module of claim 15, wherein an upper recessed part that is matched with the upper reinforcement part is formed in the upper heat transfer member such that the upper reinforcement part is seated in the upper recessed part.

17. The battery module of claim 1, wherein the upper heat transfer member includes: a lower surface coming into contact with the plurality of battery cells; and an upper surface coming into contact with the upper cooling channel, and wherein the upper heat transfer member includes a material having high thermal conductivity.

18. The battery module of claim 17, wherein a thermal conductive material is applied or a thermal conductive pad is provided between the upper heat transfer member and the upper cooling channel or between the upper heat transfer member and the plurality of battery cells.
